(19) United States
(12) Patent Application Publication
(10) Pub. No.: US 2008/0220674 A1
(43) Pub. Date: Sep. 11, 2008

(54) Environment protective multi-color pad and method of manufacturing the same

(76) Inventor: Su-Tuan Hsu Tang, Taoyuan Hsien (TW)

Correspondence Address: Hsu Tang Su-Tuan, P.O. Box 44-2049, Taipei, 10668, TW

(21) Appl. No.: 11/714,185

(22) Filed: Mar. 6, 2007

(51) Int. Cl. D03D 9/00; B29C 65/00

(52) U.S. Cl. 442/1; 264/41

(57) ABSTRACT

An environment protective multi-color pad and a method of manufacturing the same. The method includes the steps of: (a) providing and smoothening a middle net fabric and continuously outputting the middle net fabric; (b) coating environment protective soft materials on the smoothened middle net fabric according to at least one predetermined pattern through a plurality of material dispenser/flow control systems, which is for controlling the environment protective soft materials having different hues and disposed on at least one side of the middle net fabric; and (c) providing a predetermined high-temperature to the middle net fabric coated with the environment protective soft materials, wherein the predetermined high-temperature enables the environment protective soft materials to foam so that the environment protective multi-color pad having more than two colors is formed.

### BACKGROUND OF THE INVENTION

(1) Field of the Invention

The invention relates to a pad and a method of manufacturing the same, and more particularly to an environment protective multi-color pad having composite functions and a method of manufacturing the same.

(2) Description of the Prior Art

The conventional pad formed according to the conventional technology is a monochromatic pad. A main material of the monochromatic pad is a plasticizer, which is manufactured to form the pad in a very well grown method. However, the plasticizer serving as the main material always contains the phthalate material, and the kinds of the plasticizers containing this kind of poison occupy 90% of the plasticizers in the market. The main reason is that the phthalate substance enables the plastic product to be easily shaped during the manufacturing processes. Although this substance is regarded as a harmful substance in the world, it is greatly used in the global plastic industry due to the low price. More than 90% of the kinds of the plasticizers (containing the phthalate) includes BBP (benzyl phthalate), DBP (di-n-butyl phthalate), DEHP (di(2-ethylhexyl)phthalate), DINP (di-isononl phthalate), DOP (di-ctyl phthalate), DNOP (di-n-octyl phthalate), DOA (di-2-ethylhexyl adipate), NBS (butyl stearate) and TOTM (trioctyl trimellitate). In addition, the production technology is still halted on the stage of the monochromatic exterior, and it is a great break to develop the pad exterior having more than two colors. The difficulty of production is that the polyvinyl chloride material has to foam and be shaped at the high-temperature, and the shaped pad must have the excellent elasticity, the even thickness and the pretty exterior.

However, if the technology level is enhanced to the multi-color formation, the encountered bottlenecks include the following conditions.

(a) The first bottleneck is the material dispensing of the environment protective soft materials because the substance properties between multiple colors have to be balanced.

(b) The second bottleneck is the coating method. The process of coating the monochromatic polyvinyl chloride material is very simple. In the technology of coating the polyvinyl chloride materials having more than two colors, however, each color of the polyvinyl chloride material has to be controlled to distribute evenly in the same unit pad to prevent the disorder of the mixture or the distribution of multiple hues.

(c) The third bottleneck is the exterior control of foaming and shaping. There are many variables during the foaming and shaping processes of the monochromatic polyvinyl chloride material. Changes of the variables in the material control, the material dispensing control, the temperature control, the speed control, the tensile stress control and the cooling control may cause the problem of the facture exterior to be rough, too thick, the lack of material, the deformation, the hand-adhesive property and the floor-adhesive property.

Thus, the variables generated in the processes of forming the polyvinyl chloride pad by mixing more than two colors are more complicated and finer.

In view of this, it is an important subject of the present inventor to do a lot of researches and designs to solve the above-mentioned problems by providing an environment protective multi-color pad.

### SUMMARY OF THE INVENTION

The invention provides an environment protective multi-color pad and a method of manufacturing the same, wherein environment protective soft materials having more than two colors may be coated onto a middle net fabric according to a predetermined pattern with the distinct hue and the uniform thickness in the same unit.

The invention provides an environment protective multi-color pad and a method of manufacturing the same, wherein two sides of a middle net fabric are coated with multi-color environment protective soft materials to achieve the predetermined effect and enhance the product competition ability and thus the ability in the commercial success.

The invention provides an environment protective multi-color pad including a middle net fabric having a top surface and a bottom surface, and a plurality of color blocks disposed on the top surface of the middle net fabric according to a predetermined pattern. The color blocks are formed by foaming environment protective soft materials having different hues.

The invention provides an environment protective multi-color pad including a middle net fabric having a top surface and a bottom surface, and a plurality of color blocks disposed on the top and bottom surfaces of the middle net fabric according to a predetermined pattern. The color blocks are formed by foaming environment protective soft materials having different hues.

The method of manufacturing an environment protective multicolor pad includes the steps of:

(a) providing and smoothening a middle net fabric and continuously outputting the middle net fabric;

(b) coating environment protective soft materials on the smoothened middle net fabric according to at least one predetermined pattern through a plurality of material dispenser/flow control systems, which is for controlling the environment protective soft materials having different hues and is disposed on at least one side of the middle net fabric; and

(c) providing a predetermined high-temperature to the middle net fabric coated with the environment protective soft materials, wherein the predetermined high-temperature enables the environment protective soft materials to foam so that the environment protective multi-color pad having more than two colors is formed.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing an environment protective multi-color pad according to the invention;

FIG. 2 is a schematic illustration showing a method of manufacturing the environment protective multi-color pad according to a first embodiment of the invention; and

FIG. 3 is a schematic illustration showing a method of manufacturing the environment protective multi-color pad according to a second embodiment of the invention.

### DETAILED DESCRIPTION OF THE PREFERRED EMBODIMENTS

The invention provides an environment protective multi-color pad having composite functions and a net fabric serving as a supporting bone coated with polymer environment resin (PER) materials, which are dispensed separately in different regions. So, the exterior of the pad in the same unit can directly represent more than two different color systems.

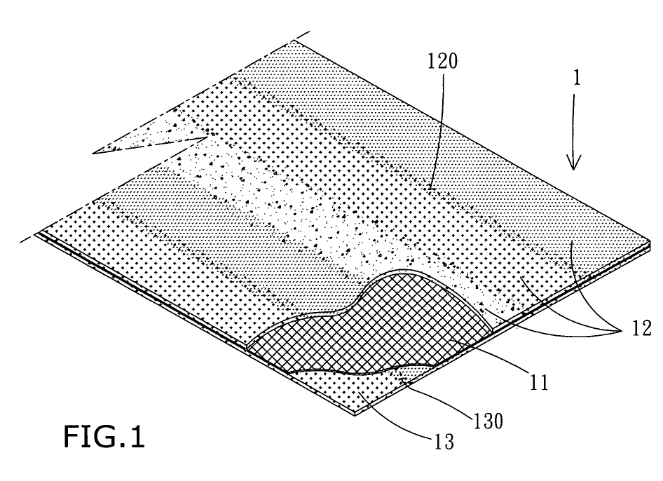

FIG. 1 is a pictorial view showing an environment protective multi-color pad 1 according to the invention. Referring to FIG. 1, the environment protective multi-color pad 1 includes a middle net fabric 11 disposed on a top surface and a bottom surface, and a plurality of color blocks 12 (or 12 and 13) disposed on one or both of the top surface and the bottom surface of the middle net fabric 11 according to a predetermined pattern. In this embodiment, the color blocks 12 and 13 are disposed on both the top surface and the bottom surface of the middle net fabric 11, and the color blocks 12 and 13 are disposed on the top surface and the bottom surface of the middle net fabric 11 according to two predetermined patterns, which are the same as or different from each other. The color blocks 12 and 13 are formed by mixing environment protective soft materials with color materials having different hues and foaming the mixtures. The environment protective PER materials include at least two compositions. The first composition is mainly composed of a dioctyl alcohol ester, a polyvinyl chloride and a polymer-natural, which may be vegetable jelly, fibrin or amylase. The second composition is mainly composed of a polymer-natural, which may be vegetable jelly, fibrin or amylase, cross-linking with a polyol and a Isocyanate or acrylic resin, or mixing with a polyolefin material TPO or TPV, which pertains to a thermalplastic elastomer (TPE). Thus, the environment protective value possessed by the environment protective PER materials is that no poisoned substance, such as azo dyes, cadmium, vinyl chloride monomer (VCM), nonylphenol, or organictin, is contained, and that the biodegradation function is possessed. Because the environment protective PER materials are coated according to different colors and different regions separately, clear and visible boundary lines 120 (or 130) are formed between the color blocks 12 (or 13) so that the hue is distinct. In addition, the predetermined pattern may be a geometric shape, a text or an image. This embodiment additionally discloses that the predetermined pattern is composed of a plurality of strip-like textures arranged in parallel.

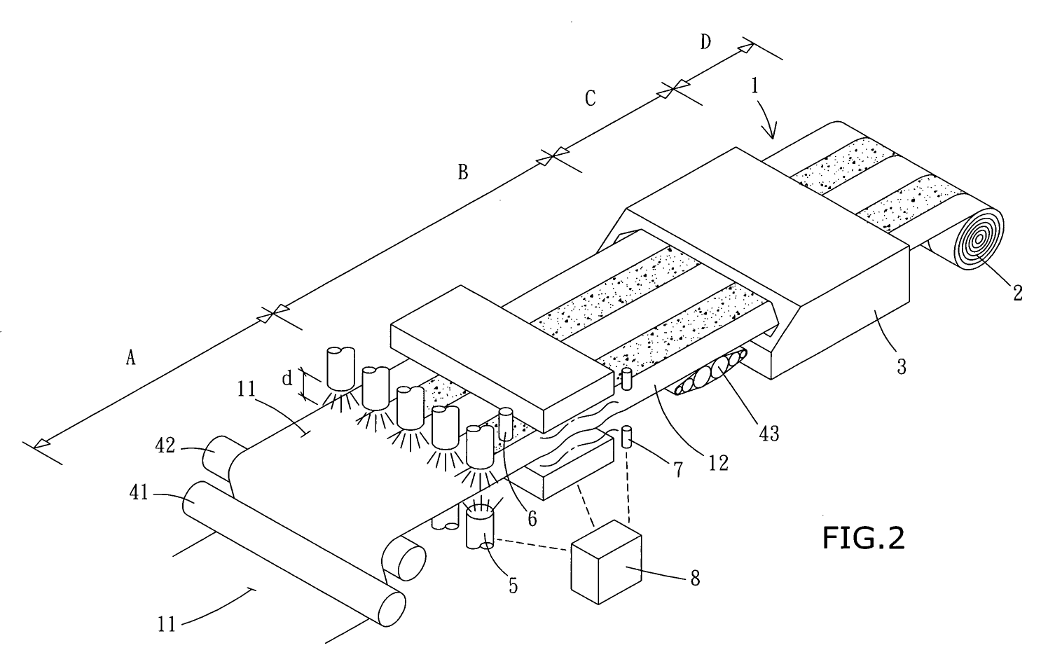

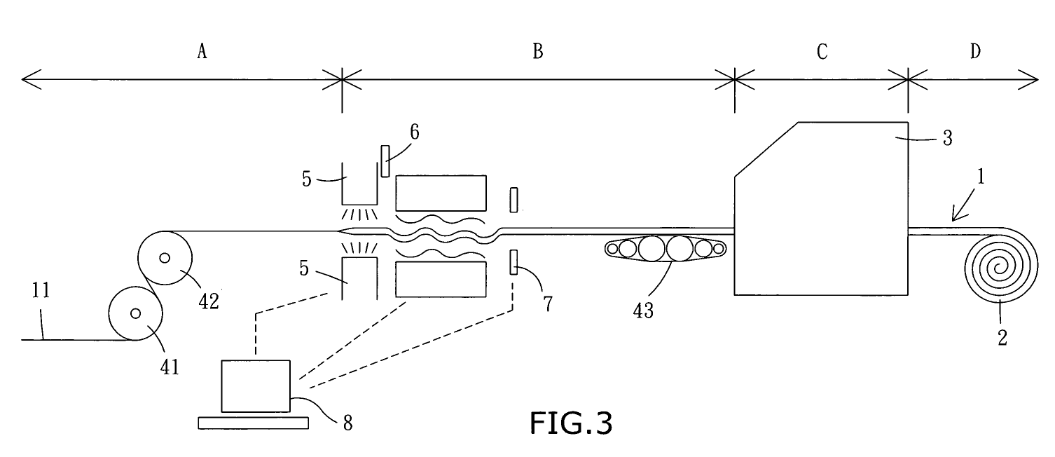

FIGS. 2 and 3 are schematic illustrations showing methods of manufacturing the environment protective multi-color pad according to two embodiments of the invention. Referring to FIGS. 2 and 3, the method includes the following steps. First, at least two rollers 41 and 42 arranged alternately are provided. A middle net fabric 11 is disposed between the two rollers 41 and 42 and tightly presses against the rollers 41 and 42. The rollers 41 and 42 drive the middle net fabric 11 to the region A so as to smoothen the middle net fabric 11 and continuously output the middle net fabric 11. Second, the middle net fabric 11 is transferred to the region B, the environment protective soft materials are coated on the smoothened middle net fabric 11 according to at least one predetermined pattern through a plurality of material dispenser/flow control systems 5, which is for controlling the environment protective soft materials having different hues and disposed on at least one side of the middle net fabric 11. The material dispenser/flow control systems 5 are separated from the middle net fabric 11 by a predetermined distance d and have at least one predetermined output rate so as to provide the suitable material outputting amount and to control the proper thickness of the foamed material. A digital image monitoring system 6 and a thickness control system 7 are sequentially disposed after the material dispenser/flow control systems 5. The material dispenser/flow control systems 5, the digital image monitoring system 6 and the thickness control system 7 are controlled by a central electrical control system 8. The digital image monitoring system 6 monitors the distribution of the coated material and can feed the monitored data back to the central electrical control system 8, which can control the thickness control system 7 to provide the adjustable wind to make the coated material, which is not distributed evenly, on the semi-facture to distribute evenly. The central electrical control system 8 may further adjust the flows of the material dispenser/flow control systems 5 according to the unevenly distributed data. As shown in FIG. 2, the material dispenser/flow control systems 5 are disposed on the same side of the middle net fabric 11. As shown in FIG. 3, the material dispenser/flow control systems 5 are disposed on opposite sides of the middle net fabric 11. Third, when the middle net fabric 11 is transferred to the region C, a predetermined high-temperature is provided to the middle net fabric 11 coated with the environment protective soft materials. The predetermined high-temperature is provided by an oven 3 to make the environment protective soft materials foam. In addition, a conveyor belt 43 (or a roller) is disposed in the front end of the oven 3 for intermediary conveying the middle net fabric 11 coated with the environment protective soft materials. Finally, the middle net fabric 11 after foaming enters the region D so that the environment protective multi-color pad 1 having more than two colors is produced. The foamed environment protective multi-color pad 1 is wound to form a tape-type environment protective multi-color pad 2.

In addition, the predetermined pattern can be disposed dynamically through various arrangements of the material dispenser/flow control systems 5 or the added motors (not shown) for driving the material dispenser/flow control systems 5. The material dispenser/flow control systems 5 may include the following aspects. In the first aspect, the material dispenser/flow control systems 5 are arranged in a straight line perpendicular to the output direction of the middle net fabric 11 so that the predetermined pattern with a plurality of strip-like textures arranged in parallel is formed. In the second aspect, the material dispenser/flow control systems 5 are arranged according to a predetermined ratio so that the predetermined pattern with the plurality of strip-like textures arranged in parallel according to the predetermined ratio is formed. In the third aspect, the material dispenser/flow control systems 5 are equally arranged so that the predetermined pattern with the equally arranged strip-like textures arranged in parallel is provided. In the fourth aspect, driving motors for moving the material dispenser/flow control systems 5 are provided and the driving motors can move the material dispenser/flow control systems 5 to finish the predetermined pattern so as to form the environment protective multi-color pad 1 with the predetermined pattern.

The environment protective soft materials, which are main materials of the environment protective multi-color pad of the invention, include an environment protective dioctyl alcohol ester or a polymer-natural. The processing properties for the above-mentioned two materials serving as main bodies are worse that that for the conventional plasticizer. Thus, the operations of associated quality control systems in the middle and post stages are more important in addition to the multi-color control system in the aspect of controlling the apparatus.

Thus, the environment protective multi-color pad and the method of manufacturing the same according to the invention have the following advantages.

First, the environment protective PER materials are coated according to different colors and different regions separately so that the distinct hue may be obtained in the same unit. In addition, it is possible to control the formed polyvinyl chloride material to have the even thickness by controlling the output amount of the material, the output speed of the material and the oven temperature.

Second, the multi-color environment protective PER materials may be formed on two sides of the middle net fabric so that the flexibility of the product design may be enhanced, and the ability of obtaining the commercial success may be enhanced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An environment protective multi-color pad, comprising:
a middle net fabric having a top surface and a bottom surface; and
a plurality of color blocks disposed on at least one of the top surface and the bottom surface of the middle net fabric according to a predetermined pattern,
wherein the color blocks are formed by foaming environment protective soft materials having different hues.

2. The multi-color pad according to claim 1, wherein the environment protective soft materials mainly comprise a dioctyl alcohol ester, a polyvinyl chloride (PVC) and a polymer-natural, which is vegetable jelly, fibrin or amylase.

3. The multi-color pad according to claim 1, wherein the environment protective soft materials mainly comprise a polymer-natural, which is vegetable jelly, fibrin or amylase, cross-linking with a polyol and a Isocyanate or an acrylic resin.

4. The multi-color pad according to claim 1, wherein the environment protective soft materials mainly comprise a polymer-natural, which is vegetable jelly, fibrin or amylase, mixing with a polyolefin material TPO or TPV, which pertains to a thermalplastic elastomer (TPE).

5. The multi-color pad according to claim 1, wherein clear and visible boundary lines are formed between the color blocks.

6. The multi-color pad according to claim 1, wherein the predetermined pattern is a plurality of strip-like textures arranged in parallel.

7. The multi-color pad according to claim 1, wherein the predetermined pattern is a geometric shape, a text, or an image.

8. A method of manufacturing an environment protective multi-color pad, the method comprising the steps of:
providing and smoothening a middle net fabric and continuously outputting the middle net fabric;
coating environment protective soft materials on the smoothened middle net fabric according to at least one predetermined pattern through a plurality of material dispenser/flow control systems, which is for controlling the environment protective soft materials having different hues disposed on at least one side of the middle net fabric; and
providing a predetermined high-temperature to the middle net fabric coated with the environment protective soft materials, wherein the predetermined high-temperature enables the environment protective soft materials to foam so that the environment protective multi-color pad having more than two colors is formed.

9. The method according to claim 8, wherein the step of smoothening the middle net fabric comprises:
providing at least two rollers disposed alternately, wherein the middle net fabric is disposed between the rollers and tightly presses against the two rollers so that the middle net fabric is smoothened.

10. The method according to claim 8, wherein in the step of coating the environment protective soft materials, the plurality of material dispenser/flow control systems contains a polyvinyl chloride material having different hues.

11. The method according to claim 8, wherein in the step of coating the environment protective soft materials, the plurality of material dispenser/flow control systems is separated from the middle net fabric by a predetermined distance, and has at least one predetermined output rate, so that a predetermined material output amount is provided.

12. The method according to claim 8, wherein in the step of coating the environment protective soft materials, the material dispenser/flow control systems are disposed on the same side or different sides of the middle net fabric.

13. The method according to claim 8, wherein in the step of coating the environment protective soft materials, the material dispenser/flow control systems are arranged in a straight line perpendicular to an output direction of the middle net fabric so that the predetermined pattern of a plurality of strip-like textures arranged in parallel is formed.

14. The method according to claim 13, wherein the step of coating the environment protective soft materials comprises:
disposing the plurality of material dispenser/flow control systems according to a predetermined ratio so as to from the predetermined pattern having the strip-like textures arranged in parallel according to the predetermined ratio.

15. The method according to claim 14, wherein the step of coating the environment protective soft materials further comprises:
equally disposing the plurality of material dispenser/flow control systems so as to form the predetermined pattern having the strip-like textures arranged in parallel and evenly.

16. The method according to claim 8, wherein the step of coating the environment protective soft materials comprises:
providing driving motors capable of moving the plurality of material dispenser/flow control systems, wherein the driving motors move the plurality of material dispenser/flow control systems according to the predetermined pattern so as to form the environment protective multi-color pad with the predetermined pattern.

17. The method according to claim 8, wherein the step of coating the environment protective soft materials further comprises:
disposing a thickness control system after the material dispenser/flow control systems.

18. The method according to claim 17, wherein the step of coating the environment protective soft materials further comprises:
providing adjustable wind to coat the materials on the thickness control system evenly.

19. The method according to claim 18, wherein the step of coating the environment protective soft materials further comprises:
disposing a digital image monitoring system between the material dispenser/flow control systems and the thickness control system, wherein the digital image monitoring system monitors distribution of the coated materials.

20. The method according to claim 8, wherein the step of coating the environment protective soft materials comprises:
providing at least one conveyor belt or a roller after the thickness control system.

21. The method according to claim 8, further comprising, after the step of foaming the environment protective soft materials, the step of:
winding the foamed environment protective multi-color pad so as to form the environment protective multi-color pad, which is a tape-type environment protective multi-color pad.
